(19) United States
(12) Patent Application Publication
(10) Pub. No.: US 2023/0071794 A1
(43) Pub. Date: Mar. 9, 2023

(54) Method and system for building lane-level map by using 3D point cloud map

(71) Applicant: KAIST (Korea Advanced Institute of Science and Technology), Daejeon (KR)

(72) Inventors: Hyun Chul SHIM, Daejeon (KR); Dae Gyu Lee, Daejeon (KR); Hyun Gi Kim, Daejeon (KR)

(21) Appl. No.: 17/827,844

(22) Filed: May 30, 2022

(30) Foreign Application Priority Data
Sep. 8, 2021 (KR) 10-2021-0119872

(51) Int. Cl. G01C 21/00; G06V 20/56

(52) U.S. Cl. CPC G01C 21/3815; G01C 21/3837; G06V 20/588

(57) ABSTRACT

A method for constructing a lane level map using a three-dimensional point cloud map is provided.

According to the method, during scan matching for estimating the location of a vehicle in the process of automatically constructing a 3D high-definition map, the amount of computation is reduced by reducing the size of a target 3D map. Thereby the method is performed fast and accurate position estimation. In addition, even if the position estimation by scan matching fails, more robust position estimation is possible by estimating the location of the vehicle using LiDAR odometry performed in parallel. The method builds and merges a precise lane map with a pre-built 3D point cloud map using such robust localization to build a more precise 3D precise map and a lane node-link map. By using these three-dimensional precise maps and maps that generate node-links in lanes, a more effective route planning algorithm that can be provided.

### BACKGROUND OF THE INVENTION

### 1. Field of the Invention

The present invention relates to a method and system for building a lane-level map using a three-dimensional point cloud map, and more specifically, to a method and system for generating a two-dimensional lane-level map utilizing a deep-learning-based lane detection, odometry based on a LiDAR sensor, and also a three-dimensional map.

### 2. Description of the Related Art

When the autonomous vehicle is driving, a technique has been disclosed in which the position of the vehicle is estimated by matching scan data of the surrounding environment detected from the vehicle to a 3D high-definition map, that is, a 3D point cloud map. Furthermore, a method for automatically constructing a multi-layered high-definition map including a three-dimensional point cloud map and a lane map using such vehicle position estimation algorithm by scan matching has also been disclosed.

However, there is a problem in that such an existing scan matching technique does not always guarantee accurate position estimation of a vehicle, particularly in an environment in which the vehicle drives at a high speed. In addition, as the scale of the pre-built 3D map is expanded, the amount of computation time for matching increases, which results in a problem in that the performance of position estimation is greatly deteriorated. If the position estimation fails, there is a limitation in automatically constructing the multi-layered high-definition map since the position of the vehicle cannot be estimated in the constructed map.

For this reason, manual corrections and verifications by a person are frequently required while constructing a map, and improvement of such time-consuming and inefficiency in the high-definition map construction process is required.

### PRIOR ART LITERATURE

### Patent Literature

(Patent Document 1) KR 10-0623653 B1

### Non-Patent Literature

(Non-patent literature 1) “P. Biber and W. Strasser. The normal distributions transform: a new approach to laser scan matching. In Proceedings 2003 IEEE/RSJ International Conference on Intelligent Robots and Systems (IROS 2003) (Cat. No. 03CH37453), volume 3, pages 2743-2748, 2003.”

### SUMMARY OF THE INVENTION

The present invention was devised to solve such a problem, and provides a method for performing fast and accurate position estimation by reducing the amount of computation through reduction of the size of a target 3D map during scan matching for estimating the location of a vehicle in the process of automatically constructing a 3D high-definition map. In addition, even if the position estimation by scan matching fails when the vehicle moves quickly, more robust position estimation is possible by estimating the location of the vehicle using LiDAR odometry performed in parallel. An object of the present invention is to build and merge a precise lane-level map with a previously constructed 3D point cloud map to provide a more accurate 3D high-definition map and a lane node-link map using such robust localization.

Another object of the present invention is to provide a more effective route planning algorithm that can be used in a navigation or autonomous driving platform by using such the 3D high-definition map and the lane node-link map.

Still another object of the present invention is to enable the autonomous driving platform to effectively utilize the address system advancement data based on the global coordinate system, by allowing the autonomous driving platform to utilize the address system advancement data based on the global coordinate system such as the established latitude-longitude coordinate system, and by automatically providing information for the utilization of the established address system advancement data to each created link.

According to one aspect of the present invention, there is provided a method for constructing a lane-level map using a three-dimensional map, comprising the steps of: (a) determining a location of a vehicle on a 3D point cloud map using data collected by scanning from a LiDAR sensor attached to the vehicle; (b) detecting a lane from an image captured by a camera installed in the vehicle; (c) determining a position of the lane on the 3D point cloud map; and, (d) accumulating the position of the lane determined in step (c) on a lane-level map as a point indicating the lane.

According to other aspect of the present invention, there is provided a system for constructing a lane map using a three-dimensional map comprising: at least one processor; and at least one memory storing computer-executable instructions, wherein the computer-executable instructions stored in the at least one memory are configured by the at least one processor to perform: (a) determining a location of a vehicle on a 3D point cloud map using data collected by scanning from a LiDAR sensor attached to the vehicle; (b) detecting a lane from an image captured by a camera installed in the vehicle; (c) determining a position of the lane on the 3D point cloud map; and, (d) accumulating the position of the lane determined in step (c) on a lane-level map as a point indicating the lane.

According to another aspect of the present invention, there is provided a method for generating a node-link based route plan for driving using a lane-level map constructed by the method of claim 1 (hereinafter referred to as a ‘lane-level map’), comprising the steps of: (a) generating nodes and a link including one or more nodes at regular intervals in the lane-level map; (b) generating a road-graph, which is an architecture having connectivity between links, for all the generated node-links; (c) receiving an input of a driving destination; (d) estimating the location of the vehicle and determining the closest node from the estimated location of the vehicle; (e) determining the closest node from the received location to the destination; (f) starting from the link including a source node, while performing the search for path planning from each link to the next linked link (hereinafter referred to as ‘propagate’), calculating cost score for each link and accumulating the cost score; (g) stopping the propagation upon reaching a node closest to the location received as the destination; (h) determining a route having the lowest accumulated cost score from the origin to the destination as a final route; and, (i) performing the steps (c) to (i) when there is an input of a destination for driving.

According to still another aspect of the present invention, there is provided an apparatus for generating node-link based route plan for driving using a lane-level map constructed by the method of claim 1 (hereinafter referred to as a ‘lane-level map’), comprising: at least one processor; and at least one memory storing computer-executable instructions, wherein the computer-executable instructions stored in the at least one memory are executed by the at least one processor to perform: (a) generating nodes and a link including one or more nodes at regular intervals in the lane-level map; (b) generating a road-graph, which is an architecture having connectivity between links, for all the generated node-links; (c) receiving an input of a driving destination; (d) estimating the location of the vehicle and determining the closest node from the estimated location of the vehicle; (e) determining the closest node from the received location to the destination; (f) starting from the link including a source node, while performing the search for path planning from each link to the next linked link (hereinafter referred to as ‘propagate’), calculating cost score for each link and accumulating the cost score; (g) stopping the propagation upon reaching a node closest to the location received as the destination; (h) determining a route having the lowest accumulated cost score from the origin to the destination as a final route; and, (i) performing the steps (c) to (i) when there is an input of a destination for driving.

According to the present invention, a method for performing fast and accurate position estimation is provided by reducing the amount of computation through reduction of the size of a target 3D map, during scan matching for estimating the location of a vehicle in the process of automatically constructing a 3D high-definition map. In addition, even if the position estimation by scan matching fails when the vehicle moves quickly, more robust position estimation is possible by estimating the location of the vehicle using LiDAR odometry performed in parallel. The present invention uses such robust localization to build and merge a precise lane-level map with a previously constructed 3D point cloud map to provide a more accurate 3D precise map and a lane node-link map.

The present invention also provides a more effective route planning algorithm that can be used in a navigation or autonomous driving platform by using such 3D precise map and lane node-link map.

The present invention further allows the autonomous driving platform to effectively utilize the address system advancement data, by enabling the autonomous driving platform to utilize the address system advancement data based on the global coordinate system such as the established latitude-longitude coordinate system, and by automatically providing information for the utilization of the established address system advancement data for each created link.

### BRIEF DESCRIPTION OF THE DRAWINGS

FIG. 1 is a flowchart of a method for automatically constructing a three-dimensional high-definition map by position estimation using the scan matching algorithm of the present invention and lane detection using a deep neural network.

FIG. 2 is a flowchart of a method of performing localization of a vehicle using the scan matching algorithm and LiDAR odometry of the present invention.

FIG. 3 is a flowchart of a method of performing lane detection and 3D high-definition map mapping using the deep neural network of the present invention.

FIG. 4 is a diagram for explaining a process performed according to the flowchart of FIG. 3.

FIG. 5 shows the configuration of a lane-level map construction system using a three-dimensional point cloud map of the present invention.

FIG. 6 illustrates an embodiment of a lane-level high-definition map constructed by the method of the present invention.

FIG. 7 shows an embodiment of a lane-level road model network composed of connections of nodes and links.

FIG. 8 is a flowchart illustrating a method for route planning using a lane-level road model network composed of connections of nodes and links.

### DETAILED DESCRIPTION OF THE INVENTION

Hereinafter, exemplary embodiments of the present invention will be described in detail with reference to the accompanying drawings. Prior to the description of the present invention, it will be noted that the terms and wordings used in the specification and the claims should not be construed as general and lexical meanings, but should be construed as the meanings and concepts that agree with the technical spirits of the present invention, based on the principle that the concepts of the terms may be properly defined by the inventor(s) to describe the invention. Since the examples described in the specification and the configurations illustrated in the drawings are merely preferred embodiments of the present invention and cannot represent all the technical sprints of the present invention, it should be understood that various equivalents and modifications that may replace them can be present.

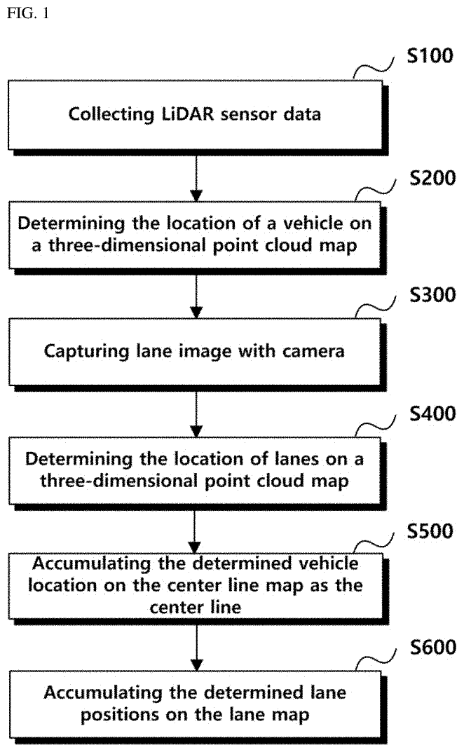

FIG. 1 is a flowchart of a method for automatically constructing a lane-level map by position estimation using the scan matching algorithm of the present invention and lane detection using a deep neural network.

First, data is collected by scanning from a LiDAR sensor attached to a driving vehicle (S100) and the location of the vehicle on a 3D point cloud map is determined using the data (S200).

That is, the LiDAR attached to the driving vehicle emits laser pulses to the surrounding object, receives the reflected pulses from the point of the objects (hereinafter, referred to as the ‘LiDAR points’) and analyzes them to determine the distance to the object, the shape of the object, etc.

In the present invention, a matching case is found by matching LiDAR points obtained through such a LiDAR scanning process with an pre-built 3D point cloud map. This technique will be referred to as a ‘scan matching’ technique. In the case of matching in scan matching, the coordinates at which the object is located on the 3D point cloud map are known, and the coordinates of the corresponding vehicle in the relative position therefrom can be accurately identified on the 3D point cloud map.

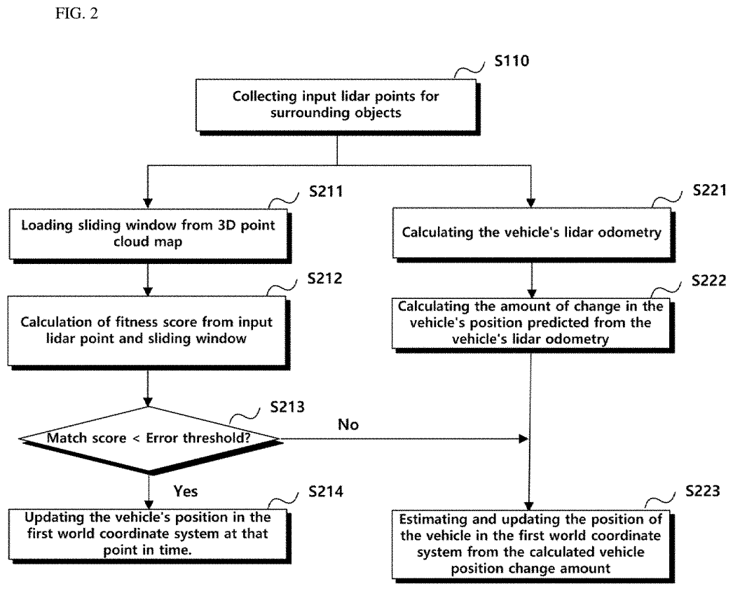

The scan using the LiDAR and the localization of the vehicle by the scan matching will be described later in more detail with reference to FIG. 2.

Thereafter, image of the road ahead is captured by the a camera installed in the vehicle (S300), lanes displayed in the captured image are detected, and the locations of the corresponding lanes on the three-dimensional point cloud map are determined (S400). A deep neural network (DNN) model trained through lots of data is used to detect lanes in the captured image. In addition, in order to determine the location of the lane on the 3D point cloud map, location information of the vehicle obtained above on the 3D point cloud map is used.

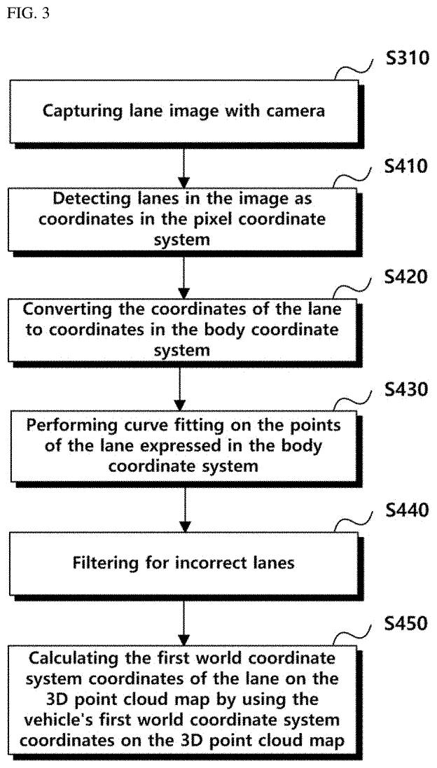

The process of detecting a lane from a captured image and determining a position of the lane on a three-dimensional point cloud map will be described later in more detail with reference to FIG. 3.

The position of the vehicle, which is continuously obtained in step S200 according to the movement of the vehicle, is accumulated as points indicating the center line on the lane-level map of the present invention, and finally the center line is obtained in the lane-level map. Here, the ‘center line’ does not mean a center line on the road but a center line in each lane.

In addition, lane positions continuously obtained in step S400 are accumulated as points indicating lanes on the lane-level map of the present invention, and finally lanes are formed in the lane-level map. In the present invention, it is possible to simultaneously obtain a left lane and a right lane of a traveling vehicle in the same way. In the lane-level map of the present invention, the center line, the left lane, and the right lane as described above are all expressed for each driving lane on the road. By using such a lane-level map, detailed and efficient route planning at the lane-level rather than the road level is possible.

With the lane-level map of the present invention, attribute information corresponding to each position of the center line and the left and right lanes accumulated on the map may be linked. Attribute information may include, for example, various information such as the shape of a lane such as a solid line, a dotted line, and a center line, speed limit at the point, classification of sidewalks or roadways, and whether or not a stop is located. It is possible to display such information corresponding to each location along with a lane-level map to a driving vehicle.

Linking of attribute information may also be performed in the following way.

The coordinates representing each point on the constructed lane-level map are unified into the latitude-longitude coordinate system. In addition, a database (hereinafter, referred to as ‘an address system advancement database’) is provided in which each point in the region is represented by a latitude-longitude coordinate system, and attribute information of the corresponding point is mapped according to the latitude and longitude coordinates. As a result, the lane-level map and the address system advancement database are unified into the latitude-longitude coordinate system, so that attribute information for each point appearing on the lane-level map can be immediately displayed on the map from the linked address system advancement database.

FIG. 2 is a flowchart of a method of performing localization of a vehicle using the scan matching algorithm and LiDAR odometry of the present invention.

As described above with reference to FIG. 1, in the present invention, a scan matching technique is used to find a corresponding case by matching the LiDAR points obtained through the LiDAR scan process (S110) to a pre-built 3D point cloud map.

To this end, a plurality of points for objects around the vehicle scanned and collected by LiDAR (hereinafter referred to as ‘input LiDAR points’) are matched with point groups on the 3D point cloud map (hereinafter referred to as ‘target point groups’) to find a matching case. However, there is a problem in that the existing scan matching technique does not always guarantee accurate position estimation of the vehicle, particularly in an environment in which the vehicle travels at a high speed. In addition, as the scale of the target 3D map is expanded, the amount of computation for matching increases, which significantly degrades the performance of position estimation.

In order to solve this problem, in the present invention, as a target point group, a group of points existing within a predetermined distance from a vehicle on a 3D point cloud map (hereinafter referred to as a ‘sliding window’) is used. That is, the entire 3D map is not used as the target point group, but only the point group of the sliding window described above is selected as the target point group for matching. Of course, since the vehicle performing the construction of the lane-level map is moving, the sliding window also continuously moves.

Referring to FIG. 2, a sliding window to be used by the vehicle at the current position is called from the 3D point cloud map for scan matching (S211). Expressing this as a formula is as follows:

dᵢ^{ψ}=∥pᵢ^{W}−xₜ∥

Here, xₜ is the position of the vehicle at time t, pᵢ^{W} is a voxelized point of the 3D point cloud map, and dᵢ^{ψ} is the distance from the vehicle to the corresponding point. The superscript ‘W’ represents a coordinate system having a specific point as an origin in the three-dimensional point cloud map (hereinafter referred to as a ‘first world coordinate system’).

When a point group in the sliding window is pᵢ^{ψ}=[pᵢ^{ψ}, . . . , pᵢ^{ψ}], each point in the sliding window is a point that satisfies,

$${p}_{j}^{ψ} = \{ \begin{matrix}{p}_{j}^{W} , & if {d}_{j}^{ψ} < ψ ( v ) \\ none , & otherwise\end{matrix} .$$

that is, a point within a certain distance from the vehicle.

In addition, the group of the aforementioned input LiDAR points is referred to as z^{B}={z₁^{B}, . . . , zₖ^{B}}. Here, zᵢ^{B} is the coordinate expressed in body coordinates with the vehicle as the origin.

A fitness score is calculated as in Equation 1 (S212).

$${S}_{t} = {\sum }_{i = 0}^{n} ‖ ( {R}_{t} {z}_{i}^{B} + {T}_{t} ) - {p}_{i}^{w} ‖ \qquad [ Equation 1 ]$$

Here, t is a specific point in time, pᵢ^{w} is a coordinate of a point in the sliding window which is a coordinate expressed in first world coordinates with a specific point on the 3D point cloud map as an origin.

Rₜ is a rotation matrix from the origin of the first world coordinate system to the current position of the vehicle, and Tₜ is a translation matrix from the origin of the first world coordinate system to the current position of the vehicle. In this zᵢ^{w}=Rₜzᵢ^{B}+Tₜ case, in Equation 1 is a point coordinate obtained by converting the zᵢ^{B} value of the input LiDAR point into the first world coordinates.

The larger the fitness score, the greater the difference between the shape of the object indicated by the input LiDAR point and the shape indicated by the point group in the sliding window, indicating that the probability that the object matches the point group of the sliding window is small. Conversely, the smaller the fitness score, the smaller the difference between the shape of the object indicated by the input LiDAR point and the shape indicated by the point group in the sliding window, indicating that the object is highly likely to match the point group of the corresponding sliding window.

From this, the error reference value (=S_{reliable}) is set in advance, and in the case of Sₜ<S_{reliable} (S213), it is determined that they match, and when not, it is determined that they do not match.

That is, in the case of Sₜ<S_{reliable}, the shape of the object indicated by the input LiDAR point matches the shape indicated by the point group in the sliding window. The location of the vehicle at this time may be determined by updating the Rₜ and the Tₜ at the time (S214).

Meanwhile, in case the scan matching result determination based on the aforementioned fitness score fails, the present invention may perform LiDAR odometry in parallel. The LiDAR odometry refers to positional coordinates obtained from the input LiDAR point on a coordinate system with the driving starting point of the vehicle as the origin (hereinafter, referred to as the ‘second world coordinate system).

That is, from the input LiDAR point, the LiDAR odometry xₜ^{L}, which is the position coordinate of the vehicle on the second world coordinate system with the driving starting point of the vehicle as the origin, is obtained (S221). From this, Δx_{t+Δt}^{L,B}, which is a value representing the amount of vehicle position change predicted by LiDAR odometry in the body coordinate system, is calculated (S222). If this is expressed as a formula, it is equivalent to Equation 2.

Δx_{t+Δt}^{L,B}=T⁻¹(x_{t+Δt}^{L}−xₜ^{L}) [Equation 2]

Here, T⁻¹ is a matrix including rotation transformation and translation transformation, and serves to transform the coordinates of the second world coordinate system into coordinates of the body coordinate system.

If the fitness score is greater than or equal to the error reference value in step S213, it is determined that scan matching has failed. In this case, Δx_{t+Δt}^{L,B} is converted to Δx_{t+Δt}^{L} (second world coordinate system), and then Rₜ and Tₜ are predicted using Δx_{t+Δt}^{L}, and the location of the vehicle at this time is determined by updating the predicted Rₜ and Tₜ (S223).

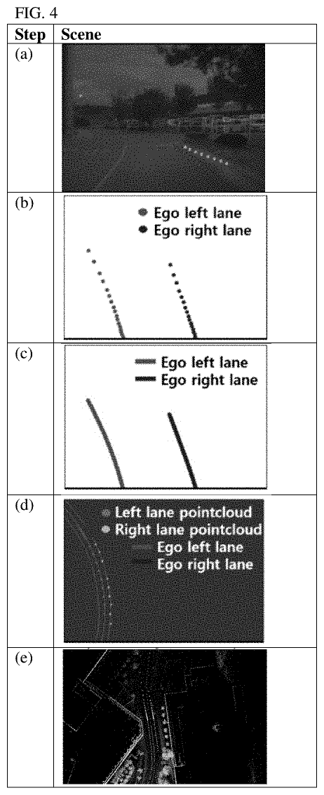

FIG. 3 is a flowchart of a method for performing lane detection and 3D high-definition map mapping using the deep neural network of the present invention, and FIG. 4 is a diagram for explaining a process performed according to the flowchart of FIG. 3.

Receiving an image captured (S310) by a camera mounted on the vehicle, and detects a lane therefrom (Scene (a) of FIG. 4). For detection of such a lane, a deep neural network (DNN) model trained in advance by lots of data may be used. The detected lane may be represented as coordinates on pixel coordinates in the captured image (S410).

The coordinates of the lanes expressed in the pixel coordinate system are converted into coordinates on the body coordinate system with the vehicle as the origin (S420) (Scene (b) of FIG. 4). In Scenes (a) and (b) of FIG. 4, red indicates a left lane of the vehicle, and blue indicates a right lane of the vehicle.

The transformation to coordinates in the body coordinate system is made by below relation.

$$[ \begin{matrix}\begin{matrix}x \\ y\end{matrix} \\ 1\end{matrix} ] = {H}^{- 1} [ \begin{matrix}\begin{matrix}u \\ v\end{matrix} \\ 1\end{matrix} ]$$

In this case,

$$[ \begin{matrix}\begin{matrix}u \\ v\end{matrix} \\ 1\end{matrix} ]$$

is the coordinates of the lane indicated in the pixel coordinate system,

$$[ \begin{matrix}\begin{matrix}x \\ y\end{matrix} \\ 1\end{matrix} ]$$

is the coordinates of the lane indicated in the body coordinate system, and the matrix H⁻¹ is inverse perspective mapping (IPM), where the matrix H is a matrix that satisfies below relation.

$$[ \begin{matrix}\begin{matrix}u \\ v\end{matrix} \\ 1\end{matrix} ] = K [ \begin{matrix}{r}_{11} & {r}_{12} & {t}_{1} \\ {r}_{21} & {r}_{22} & {t}_{2} \\ {r}_{31} & {r}_{32} & {t}_{3}\end{matrix} ] [ \begin{matrix}\begin{matrix}x \\ y\end{matrix} \\ 1\end{matrix} ] = H [ \begin{matrix}\begin{matrix}x \\ y\end{matrix} \\ 1\end{matrix} ]$$

Here,

$$[ \begin{matrix}{r}_{11} & {r}_{12} \\ {r}_{21} & {r}_{22} \\ {r}_{31} & {r}_{32}\end{matrix} ]$$

is the rotation transformation matrix,

$$[ \begin{matrix}{t}_{1} \\ {t}_{2} \\ {t}_{3}\end{matrix} ]$$

is the translation matrix, and K is the intrinsic matrix related to the camera's internal parameters.

The existing methods of obtaining the next best world coordinate system using LIDAR required O(12n_pointcloud) multiplication operation for the number of LIDAR point clouds, n_pointcloud, using a projection matrix (3×4). The present invention requires a multiplication operation of O(9n_lane) for the number of points n_lane of the lane using the homography matrix H under the assumption that the lane is a plane. Since n_pointcloud is much larger than n_lane, the method of the present invention has an advantage in that the amount of computation is much less, enabling rapid computation.

With respect to the points of the lane expressed in the body coordinate system, curve fitting is performed to form a curve (S430) (Scene (c) of FIG. 4). In addition, filtering may be performed on the incorrect lane (S440).

Thereafter, the coordinates of the lane on the body coordinate system are converted into coordinates on a 3D point cloud map (S450) (Scene (d) of FIG. 4). The transformation into coordinates on the 3D point cloud map is performed using the location information of the vehicle on the 3D point cloud map determined in FIG. 2 (S214 and S223). That is, knowing the location of the vehicle in the first world coordinate system and knowing the coordinates of the lane expressed in the body coordinate system with the vehicle as the origin, it is possible to know the coordinates of the first world coordinate system on the three-dimensional point cloud map of the lane.

Scene (e) of FIG. 4 shows a lane-level map of the present invention displayed on a three-dimensional point cloud map. White dots in parallel indicate the left and right lanes, and the red line in the center indicates the location of the vehicle, that is, the center line.

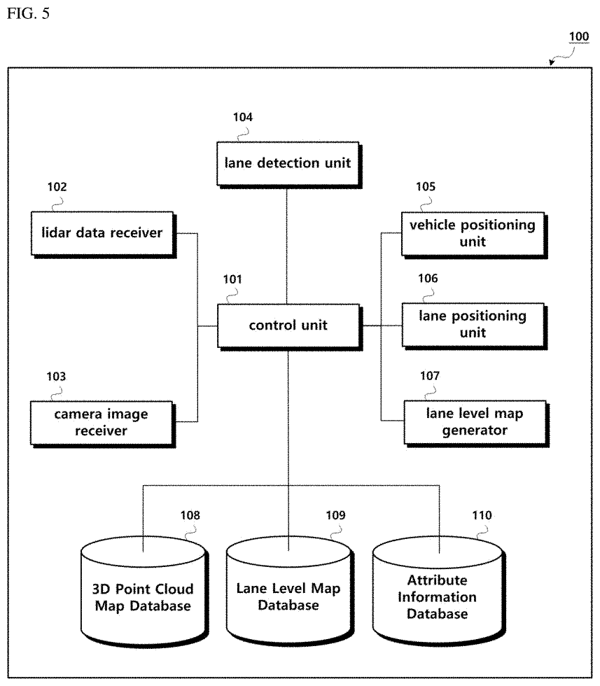

FIG. 5 is a diagram showing the configuration of a lane-level map construction system 100 using a three-dimensional point cloud map of the present invention.

Since the lane-level map construction method using the three-dimensional point cloud map of the present invention has been described in detail with reference to FIGS. 1 to 4, the system for performing such a method is briefly explained regarding function of its components with reference to FIG. 5.

The control unit 101 controls each of the following components of the system 100 for constructing a lane-level map using a three-dimensional point cloud map of the present invention, and performs a series of processes related to construction of a lane-level map using the three-dimensional point cloud map.

The LiDAR data receiving unit 102 receives a pulse signal scanned by a LiDAR mounted on the vehicle, and grasps LiDAR point information such as a distance or coordinates of the scanned object from the received pulse signal.

The camera image receiving unit 103 receives an image captured by a camera mounted on a vehicle.

The lane detection unit 104 detects a lane from the image captured by the camera and recognizes coordinates of the lane according to a pixel coordinate system. For lane detection, a deep neural network (DNN) model may be used.

The vehicle positioning unit 105 obtains the current location of the vehicle from the collected LiDAR point information and the 3D point cloud map of the 3D point cloud map database 108. The location of the vehicle is obtained as a coordinate value according to the first world coordinate system based on a specific point on the 3D point cloud map. These processes were described in detail with reference to FIGS. 1 and 2.

The lane positioning unit 106 converts the detected lane information into the body coordinate system and finally converts the detected lane information into the first world coordinate system to determine the position of the lane. These processes were described in detail with reference to FIGS. 1 and 3.

The lane-level map generating unit 107 accumulates the vehicle position information determined by the vehicle position determining unit 105 and the lane position information determined by the lane position determining unit 106 on the lane-level map, and stores the finally formed lane-level map in the lane-level map database 109. Also, the lane-level map generator 107 may map attribute information corresponding to each point of the lane-level map stored in the attribute information database 110 to the lane-level map. Accordingly, it is possible to provide various information about each point on a lane-level map to be provided to users in the future.

Furthermore, as described above, in the attribute information database 110, attribute information for each point in a corresponding region may be mapped and stored based on a global coordinate system called a latitude-longitude coordinate system. In this case, the lane-level map generating unit 107 may also perform a role of unifying and storing the coordinates of each point of the lane-level map stored in the lane-level map database 109 as a latitude-longitude coordinate system. The lane-level map and attribute information are unified into the latitude-longitude coordinate system, and when providing the lane-level map to the user, information corresponding to each point may be easily provided as information based on the corresponding latitude-longitude coordinates in the attribute information data. In this case, the attribute information database 110 serves as the ‘address system advancement database’ as described above with reference to FIG. 1.

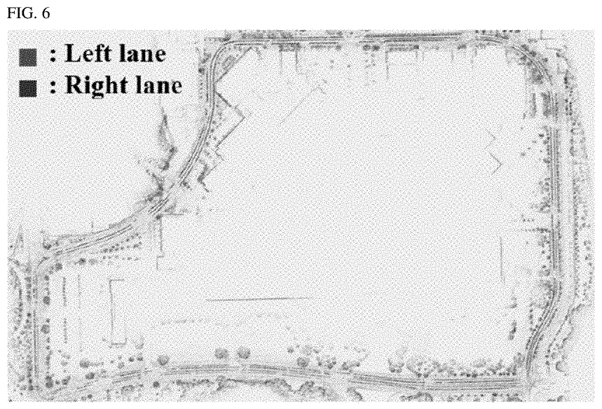

FIG. 6 shows an embodiment of a lane-level high-definition map constructed by the method of the present invention.

The red line indicates the left lane of the vehicle and the blue line indicates the right lane of the vehicle.

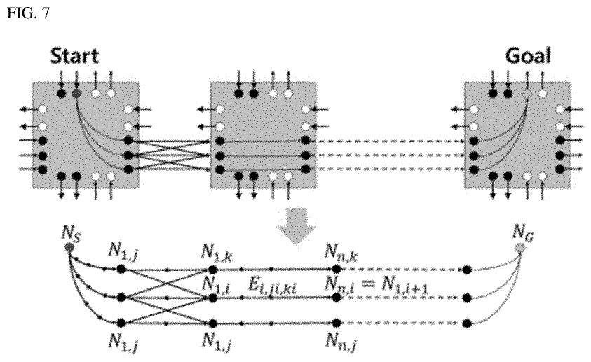

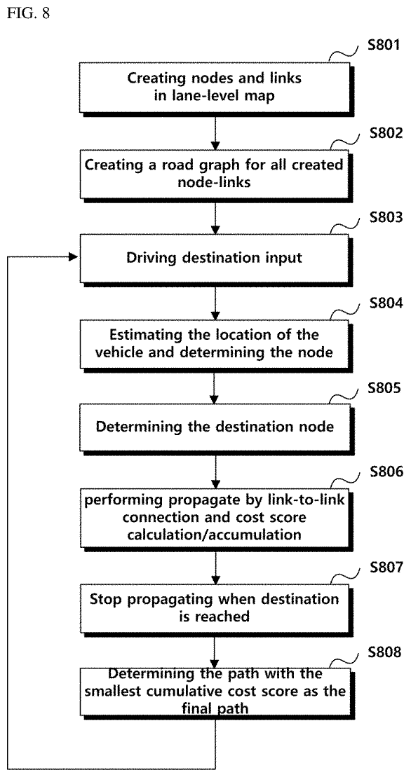

FIG. 7 shows an embodiment of a lane-level road model network configured by connecting nodes and links, and FIG. 8 is a flowchart illustrating a method for route planning using a lane-level road model network composed of connections of nodes and links.

First, node(s) and link(s) for performing future path planning are created (S801). That is, in the lane-level map as described with reference to FIGS. 1 to 6, node(s) and link(s) including one or more nodes are generated at regular intervals. A node is used to determine a location corresponding to a vehicle and a destination, and a link is a basic unit for future route planning. Path planning is performed through a process of searching (hereinafter referred to as ‘propagate’) by making connection between links. This will be described later.

For all the generated node-links, a road-graph, which is an architecture having connectivity between links, is generated (S802). That is, the load-graph is a graph that includes all nodes and links, but also includes a structure for whether connection between links are possible. At this time, attribute information to be used for route planning may be automatically assigned to each generated link. The attribute information may include, for example, whether the link is a lane changeable link, the direction in which the vehicle travels, and information such as address information of the corresponding point.

Thereafter, when the destination of the driving input by the user is received (S803), the location of the corresponding vehicle is estimated, and a node closest to the estimated location of the vehicle is determined as the node of the vehicle (S804). Also, with respect to the input destination, the node closest to the location received as the destination is determined as the destination node (S805).

As described above, the path planning of the present invention is performed in units of links, and propagating for path planning is performed starting from a link including a source node and proceeding to the next link connected in each link (S806). At this time, a cost score for each link is calculated, and the cost score calculated from each link is accumulated (S806). Such propagation may be made for all possible links from the origin to the destination, but if the shortest route is propagated without penalty points to be added to the cost score, the propagation may be finally determined as the route.

These cost scores include, by default, the length of that link. That is, as the length of a link increases, the cost score increases, and acts as a detrimental factor in selecting a corresponding path. In addition, a score according to previously input attribute information of the corresponding link may be added to the cost score. For example, a link that can change lanes may also be added to the cost score as a penalty score. In addition, even if the propagation process moves in a direction different from the intended purpose, it may be added to the cost score as a penalty score.

When the closest node is reached from the location received as the destination, propagation is stopped (S807). Thereafter, a route having the lowest accumulated cost score from the origin to the destination is determined as the final route (S808).

Afterwards, if there is input of a destination again, the above steps (S803) to (S808) are performed.

What is claimed is:

1. A method for constructing a lane-level map using a three-dimensional map, comprising the steps of:
(a) determining a location of a vehicle on a 3D point cloud map using data collected by scanning from a LiDAR sensor attached to the vehicle;
(b) detecting a lane from an image captured by a camera installed in the vehicle;
(c) determining a position of the lane on the 3D point cloud map; and,
(d) accumulating the position of the lane determined in step (c) on a lane-level map as a point indicating the lane.

2. The method of claim 1, wherein the step (a) includes the steps of:
(a1) matching a plurality of points for objects around the vehicle that are scanned and collected by LiDAR (hereinafter referred to as ‘input LiDAR points’) with a point group on the 3D point cloud map (hereinafter referred to as a ‘target point group’) to find a corresponding case; and
(a2) determining, if a matching case is found in the step (a1), the location of the vehicle as coordinates on the 3D point cloud map.

3. The method of claim 2, wherein the target point group is a group of points existing within a predetermined distance from the vehicle on the 3D point cloud map (hereinafter referred to as a ‘sliding window’).

4. The method of claim 3, wherein, in the step (a1), it is determined as matched in the case of Sₜ<S_{reliable}, where Sₜ is a fitness score, S_{reliable} is a preset error reference value, and Sₜ is calculated as
$${S}_{t} = {\sum }_{i = 0}^{n} ‖ ( {R}_{t} {z}_{i}^{B} + {T}_{t} ) - {p}_{i}^{w} ‖ ,$$
where t is a specific time point, zᵢ^{R} is the coordinates of the input LiDAR point, coordinates expressed in body coordinates with the vehicle as the origin, pᵢ^{w} is the coordinates of the points in the sliding window, and a specific point on the three-dimensional point cloud map as the origin coordinates expressed in the first world coordinate system, Rₜ is the rotation matrix from the origin of the first world coordinate system to the current position of the vehicle, Tₜ is the parallel movement from the origin of the first world coordinate system to the current position of the vehicle is a matrix, and zᵢ^{w}=Rₜzᵢ^{B}+Tₜ is a point coordinate obtained by converting the input LiDAR point zᵢ^{B} value into first world coordinates, and
wherein, in case it is determined as matched in the step (a1), the location of the vehicle is updated with the Rₜ and Tₜ at the time in the step (a2).

5. The method of claim 4,
before the step (a2), further comprising the steps of:
(a11) obtaining, from the input LiDAR point, the vehicle's position coordinates (hereinafter ‘LiDAR odometry’) on a coordinate system with the driving start point of the vehicle as the origin (hereinafter ‘second world coordinate system’) and (a12) calculating Δx_{t+Δt}^{L,B}=T⁻¹(x_{t+Δt}^{L}−xₜ^{L}), and
in case it is determined as matched in step (a1), further comprising the step of:
(a3) converting Δx_{t+Δt}^{L,B} to Δx_{t+Δt}^{L}, predicting Rₜ and Tₜ using Δx_{t+Δt}^{L}, and updating them to Rₜ and Tₜ at that time, where x_{t+Δt}^{L} is the LiDAR odometry at time t+Δt, xₜ^{L} is the LiDAR odometry at time t, Δx_{t+Δt}^{L,B} is the amount of change in the position of the vehicle expressed in the body coordinate system predicted by LiDAR odometry, Δx_{t+Δt}^{L} is the transformation of the Δx_{t+Δt}^{L,B} into the second world coordinate system, and the T⁻¹ is the coordinates of the second world coordinate system to convert the coordinates of the body coordinate system is a matrix.

6. The method of claim 1, wherein the lane detected in step (b) is coordinates on pixel coordinates in the captured image.

7. The method of claim 6, wherein the step (c) includes:
(c1) converting the coordinates of the lane into coordinates on body coordinates with the vehicle as the origin; and,
(c2) converting the coordinates of the lane on the body coordinate system into coordinates on the 3D point cloud map.

8. The method of claim 7, wherein, in the step (c1), the transformation into coordinates in the body coordinate system may be performed by
$$[ \begin{matrix}\begin{matrix}x \\ y\end{matrix} \\ 1\end{matrix} ] - {H}^{- 1} [ \begin{matrix}\begin{matrix}u \\ v\end{matrix} \\ 1\end{matrix} ] ,$$
where
$$[ \begin{matrix}\begin{matrix}u \\ v\end{matrix} \\ 1\end{matrix} ]$$
is the coordinates of the lane indicated in the pixel coordinate system,
$$[ \begin{matrix}\begin{matrix}x \\ y\end{matrix} \\ 1\end{matrix} ]$$
is the coordinates of the lane indicated in the body coordinate system, and
the matrix H⁻¹ is inverse perspective mapping in which H is a matrix satisfying
$$[ \begin{matrix}\begin{matrix}u \\ v\end{matrix} \\ 1\end{matrix} ] = K [ \begin{matrix}{r}_{11} & {r}_{12} & {t}_{1} \\ {r}_{21} & {r}_{22} & {t}_{2} \\ {r}_{31} & {r}_{32} & {t}_{3}\end{matrix} ] [ \begin{matrix}\begin{matrix}x \\ y\end{matrix} \\ 1\end{matrix} ] = H [ \begin{matrix}\begin{matrix}x \\ y\end{matrix} \\ 1\end{matrix} ] ,$$
where
$$[ \begin{matrix}{r}_{11} & {r}_{12} \\ {r}_{21} & {r}_{22} \\ {r}_{31} & {r}_{32}\end{matrix} ]$$
is a rotation transformation matrix,
$$[ \begin{matrix}{t}_{1} \\ {t}_{2} \\ {t}_{3}\end{matrix} ]$$
is a translation matrix, and
K is an intrinsic matrix related to the camera's internal parameters.

9. The method of claim 7, between the steps (c1) and (c2), further including:
(c11) performing curve fitting with respect to the points of the lane expressed in the body coordinate system in the step (c1).

10. The method of claim 7, wherein, in the step (c2), the transformation into coordinates on the 3D point cloud map is performed by using the location information of the vehicle on the 3D point cloud map determined in the step (a).

11. The method of claim 1, further comprising:
(e) interworking attribute information corresponding to each point of the lane accumulated on the map in step (d).

12. The method of claim 1, further comprising the step of:
(d1) accumulating the location of the vehicle determined in step (a) on a lane-level map as a point indicating a center line.

13. The method of claim 12, further comprising the step of:
(e1) interworking attribute information corresponding to each point of the central line accumulated on the map in step (d1).

14. The method of claim 11, wherein the interworking of the attribute information is performed in such a way that the coordinates representing each point on the constructed lane-level map are unified into the latitude-longitude coordinate system in order to link with the database in which the address and attribute information are mapped and stored in the latitude-longitude coordinate system.

15. The method of claim 13, wherein the interworking of the attribute information is performed in such a way that the coordinates representing each point on the constructed lane-level map are unified into the latitude-longitude coordinate system in order to link with the database in which the address and attribute information are mapped and stored in the latitude-longitude coordinate system.

16. A system for constructing a lane map using a three-dimensional map comprising:
at least one processor; and
at least one memory storing computer-executable instructions, wherein the computer-executable instructions stored in the at least one memory are configured by the at least one processor to perform: (a) determining a location of a vehicle on a 3D point cloud map using data collected by scanning from a LiDAR sensor attached to the vehicle; (b) detecting a lane from an image captured by a camera installed in the vehicle; (c) determining a position of the lane on the 3D point cloud map; and, (d) accumulating the position of the lane determined in step (c) on a lane-level map as a point indicating the lane.

17. A method for generating a node-link based route plan for driving using a lane-level map constructed by the method of claim 1 (hereinafter referred to as a ‘lane-level map’), comprising the steps of:
(a) generating nodes and a link including one or more nodes at regular intervals in the lane-level map;
(b) generating a road-graph, which is an architecture having connectivity between links, for all the generated node-links;
(c) receiving an input of a driving destination;
(d) estimating the location of the vehicle and determining the closest node from the estimated location of the vehicle;
(e) determining the closest node from the received location to the destination;
(f) starting from the link including a source node, while performing the search for path planning from each link to the next linked link (hereinafter referred to as ‘propagate’), calculating cost score for each link and accumulating the cost score;
(g) stopping the propagation upon reaching a node closest to the location received as the destination;
(h) determining a route having the lowest accumulated cost score from the origin to the destination as a final route; and,
(i) performing the steps (c) to (i) when there is an input of a destination for driving.

18. The method of claim 17, wherein the cost score includes the length of the link.

19. The method of claim 18, wherein attribute information to be used for route planning is automatically given to each generated link, and
wherein a score according to attribute information of the corresponding link may be added to the cost score.

20. An apparatus for generating node-link based route plan for driving using a lane-level map constructed by the method of claim 1 (hereinafter referred to as a ‘lane-level map’), comprising:
at least one processor; and
at least one memory storing computer-executable instructions, wherein the computer-executable instructions stored in the at least one memory are executed by the at least one processor to perform: (a) generating nodes and a link including one or more nodes at regular intervals in the lane-level map; (b) generating a road-graph, which is an architecture having connectivity between links, for all the generated node-links; (c) receiving an input of a driving destination; (d) estimating the location of the vehicle and determining the closest node from the estimated location of the vehicle; (e) determining the closest node from the received location to the destination; (f) starting from the link including a source node, while performing the search for path planning from each link to the next linked link (hereinafter referred to as ‘propagate’), calculating cost score for each link and accumulating the cost score; (g) stopping the propagation upon reaching a node closest to the location received as the destination; (h) determining a route having the lowest accumulated cost score from the origin to the destination as a final route; and, (i) performing the steps (c) to (i) when there is an input of a destination for driving.
